(19) United States
(12) Patent Application Publication
(10) Pub. No.: US 2003/0234746 A1
(43) Pub. Date: Dec. 25, 2003

(54) SUB-REFLECTOR SHAPING IN AN UNFURLABLE REFLECTOR ANTENNA SYSTEM

(76) Inventors: Minh Quyen Tang, San Jose, CA (US); David Ford, Watson Ville, CA (US)

Correspondence Address: J. E. Kosinski, Loral Space & Communications, Ltd., Suite 303, 655 Deep Valley Drive, Rolling Hills Estates, CA, 90274, US

(21) Appl. No.: 10/177,467

(22) Filed: Jun. 20, 2002

(51) Int. Cl. H01Q 13/00

(52) U.S. Cl. 343/781 CA; 343/781 P

(57) ABSTRACT

An antenna system for producing a beam of radiated radio frequency energy. The system comprises an antenna feed, a shaped sub-reflector, and an unfurlable main reflector. The antenna feed supplies radiated radio frequency energy. The shaped sub-reflector receives the radiated radio frequency energy from the antenna feed. The unfurlable main reflector receives and reflects the radiated radio frequency energy from the shaped sub-reflector as a shaped beam having a predetermined shape. The sub-reflector has a configuration that shapes the beam reflected from the unfurlable main reflector to have the predetermined shape.

### BACKGROUND OF THE INVENTION

1. Field of the Invention

The present invention relates to an antenna system and, more particularly, to an antenna system having a sub-reflector and an unfurlable main reflector for producing a beam of energy of a predetermined shape.

2. Brief Description of Related Developments

Antenna radiation pattern coverage of a non-circularly symmetric region is often desired for satellite applications. Such “shaped” beam patterns are currently obtained using the following two conventional techniques.

(1) Use of focused optical system {parabolic main reflector and (optionally) a hyperbolic/elliptical subreflector} illuminated by a multiple feed element cluster connected to a microwave power combining or dividing network, or

(2) Use of a non-focused optical system, “shaped surface” non-parabolic main reflector and (optionally) a non-hyperbolic/elliptical sub-reflector illuminated by a single feed element.

In either case, additional feed elements may be added to form different “beams”.

U.S. Pat. No. 5,790,077 discloses an example of a shaped dual reflector antenna system. The disclosed system comprises a main reflector having a hyperboloidal or ellipsoidal reflective surface profile that is selected such that the cross-polarization of the contoured output RF signal beam of the resulting antenna structure is reduced. The antenna system disclosed in the aforementioned patent may be configured in both Cassegrain and Gregorian geometries.

The latter beam “shaping” technique generally provides superior beam performance efficiency, but requires the reflector surfaces to be non-symmetrical and non-monotonic in shape. Because most applications require a reflector size less than about 4 meters in diameter, the “shaped” reflector surfaces can be manufactured as “solid” or “rigid” (i.e. non-collapsible) structures, which attach rigidly to a satellite body and are contained within the launch vehicle fairing.

However, there are numerous applications where reflector sizes larger than 4 meters are desired. “Solid” antennas, which are significantly larger than 4 meters, cannot be stowed readily in the fairings of most, if not all, presently available commercial launch vehicles. To avoid interference with the launch vehicle fairing while stowed, unfurlable antennas have been developed. These antenna structures are composed of wire or mesh and “stow” as cylinder and “unfurl” after launch into a parabolic reflector surface. This mechanical operation is similar to that of a conventional umbrella. The reflecting surface of the “unfurlable” antennas is generated by the wires and mesh controlled by tension system, and hence, a true “shaped” surface (i.e., non-symmetrical and non-monotonic) cannot be readily formed using current state-of-the-art mechanisms and structures available for such antennas. Accordingly, the reflecting surface of “unfurlable” antennas is generally limited to being parabolic.

### SUMMARY OF THE INVENTION

In accordance with the first embodiment of the present invention an antenna system for producing a beam of radiated radio frequency energy is provided. The system comprises an antenna feed, a shaped sub-reflector, and an unfurlable main reflector. The antenna feed supplies radiated radio frequency energy. The shaped sub-reflector receives the radiated radio frequency energy from the antenna feed. The unfurlable main reflector receives and reflects the radiated radio frequency energy from the shaped sub-reflector as a shaped beam having a predetermined shape. The sub-reflector has a configuration that shapes the beam reflected from the unfurlable main reflector to have the predetermined shape.

In accordance with a method of the present invention, a method for producing a beam of energy of a predetermined shape with an antenna system is provided. The method comprises supplying radiated radio frequency energy from an antenna feed, receiving the radiated radio frequency energy in a shaped sub-reflector, reflecting the radiated radio frequency energy from the shaped sub-reflector, receiving the reflected energy from the shaped sub-reflector in a unfurlable main reflector, and reflecting the energy from the unfurlable main reflector. The shaped sub-reflector reflects the radiated radio frequency energy as a shaped beam. The shaped beam is received by the unfurlable main reflector. The unfurlable main reflector reflects the shaped beam with a predetermined shape.

In accordance with another embodiment of the present invention a spacecraft is provided. The spacecraft comprises a spacecraft body, and an antenna connected to the spacecraft. The antenna is connected to the spacecraft body for producing a beam of radiated energy of a predetermined shape. The antenna includes an antenna feed, a shaped sub-reflector, and an unfurlable main reflector. The antenna feed supplies radiated radio frequency energy. The shaped sub-reflector receives the radiated radio frequency energy from the antenna feed. The unfurlable main reflector receives and reflects the radiated radio frequency energy from the shaped sub-reflector as a shaped beam having a predetermined shape. The sub-reflector has a configuration that shapes the beam reflected from the unfurlable main reflector to have the predetermined shape.

In accordance with yet another embodiment of the present invention, a spacecraft antenna is provided. The antenna comprises an antenna feed, a shaped sub-reflector, and an unfurlable main reflector. The shaped sub-reflector reflects energy from the antenna feed. The unfurlable main reflector reflects and directs energy to a predetermined region on the ground. The shaped sub-reflector is shaped so that the unfurlable main reflector reflects a shaped beam.

In accordance with still another embodiment of the present invention, a spacecraft antenna system is provided. The antenna system comprises an antenna feed, a first optical element, and a second optical element. The antenna feed supplies a beam of radio frequency energy. The first optical element reflects the beam from the antenna feed. The second optical element reflects and directs the beam at a predetermined region on the ground. The second optical element is unfurlable. The beam reflected from the second optical element is a shaped beam having a predetermined shape. The first optical element changes the shape of the beam from the antenna feed so that the shaped beam reflected from the second optical element has the predetermined shape.

### BRIEF DESCRIPTION OF THE DRAWINGS

The foregoing aspects and other features of the present invention are explained in the following description, taken in connection with the accompanying drawings, wherein:

FIG. 1 is a schematic view of an orbiting spacecraft incorporating features of the present invention, the spacecraft having an antenna system for use in a communication link which illuminates an area on Earth;

FIG. 2 is a graphical representation of a reflector surface of an antenna of the spacecraft in FIG. 1 with the contours of shaped beams from a shaped sub-reflector antenna of the spacecraft; and

FIG. 3 is another graphical representation of a reflector of an antenna with the contour of nominal (i.e. non-shaped) beams from a non-shaped sub-reflector antenna in accordance with the prior art.

### DETAILED DESCRIPTION OF THE PREFERRED EMBODIMENT(s)

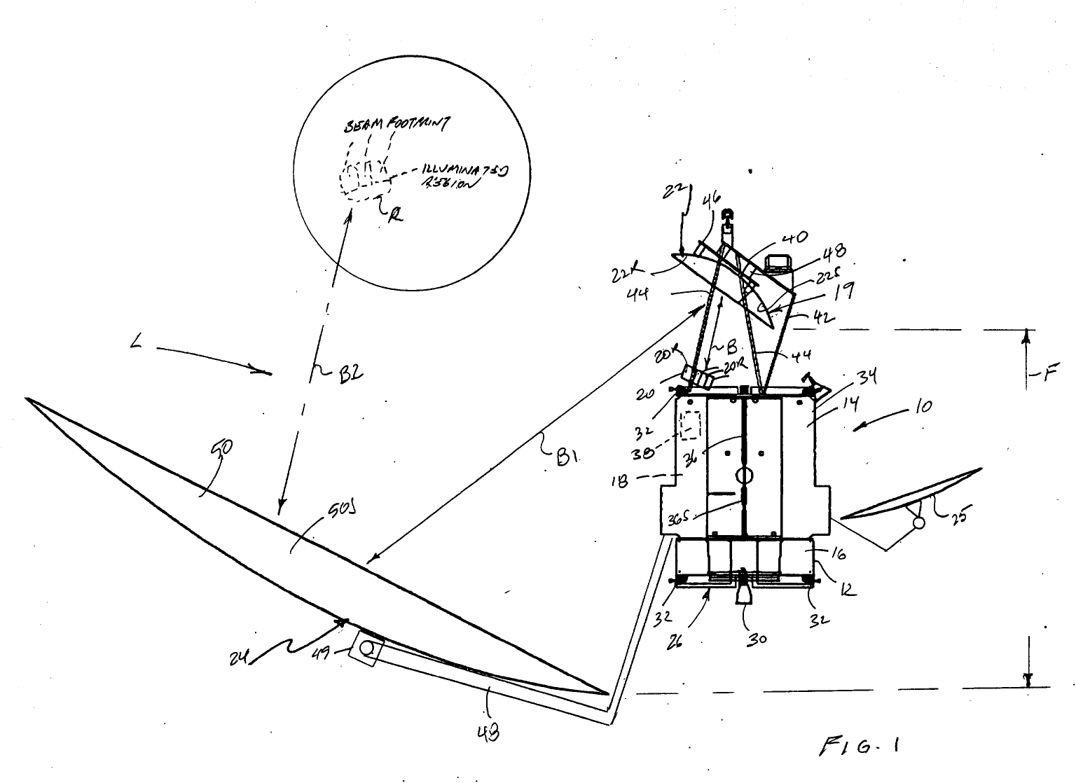

Referring to FIG. 1, a schematic view of an orbiting spacecraft 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

The spacecraft 10 in FIG. 1 is shown in earth orbit. The spacecraft orbit may have any suitable orbit parameters and may have any suitable altitude. Thus, spacecraft 10 may be in any one of a LEO, MEO or GEO orbits as desired. As seen in FIG. 1, spacecraft 10 generally comprises a spacecraft bus 12 and a payload 14. The payload 14 is supported from bus 12. The bus 12 has means for controlling station keeping and attitude of the spacecraft 10. The payload 14 has a communication system 18 with an antenna system 19 used for establishing communication links between the spacecraft 10 and ground. The antenna system 19 generally includes a feed system 20, a subreflector 22, and a main reflector 24. The feed system 18 generates an RF beam B, which is directed to the sub-reflector 22. The sub-22 reflects the beam transmitted from feed system 18 to the main reflector 24. The main reflector 24 in turn reflects the beam reflected from the subreflector 22, to illuminate a region R on the ground. The feed system generates a nominal beam B which may have a generally circular symmetrical cross-section. The sub-reflector 22 has a shaped reflector which causes the beam B1 reflected from the subreflector 22 to have a cross-section with a desired non-circularly symmetric shape. The reflected beam B2 from the main reflector 24 has substantially the same cross-section shape as the shaped beam B1, from the sub-reflector 22. The region R on the ground illuminated by beam B2, reflected from main reflector 24, is thus, provided with a desired non-circularly symmetric footprint corresponding to the non-circularly symmetric cross-section shape of the reflected beam B1 from the sub-reflector 22.

In greater detail now, and with reference still to FIG. 1, the bus 12 of the spacecraft 10 generally includes a frame or support structure 16, an orbital maneuvering system 26 and processors or controllers (not shown) for operating the maneuvering system 26. The spacecraft bus 12 may also include an electrical power system (not shown), a command communication system 25 (for sending spacecraft ephemeris data to a control ground station and receiving control commands from the ground station), as well as any other desired systems and devices for launching and maintaining spacecraft 10 in the desired orbit. The bus frame 16 provides a mounting platform for the orbital maneuvering system, controller, power system and the other spacecraft bus systems and devices, as well as for the payload 14 as is schematically shown in FIG. 1. The orbital maneuvering system 26 may generally include one or more main thrusters 30 (one main thruster is shown in FIG. 1 for example purposes only) used for orbit injection and station keeping maneuvers. The orbital maneuvering system 26 may also include a group of attitude thrusters 32 and/or momentum wheels (not shown) which stabilize the spacecraft 10 about three orthogonal axes. In alternate embodiments, the spacecraft need not be stabilized about three axes. The maneuvering system also includes the propellant tanks and piping (not shown) supplying suitable propellant to the thrusters 30, 32, as well as power cells and power distribution network powering the momentum wheels. Control of the maneuvering system 26 is effected by the onboard processors and controllers and/or by commands transmitted from ground stations via the command communication system 25.

Still referring to FIG. 1, the spacecraft payload 14 generally includes a housing or support frame 34, a power system 36 and a communication system 18. The payload 34 housing provides a foundation for the power system 36 and communication system 18. The payload housing 34 also provides means for interfacing the payload 14 to the spacecraft bus 12. The power system 36, may include a desired number of solar arrays or panels 36S which for example depend from the housing. The power system 36 may also include power cells (not shown) and/or any other suitable power generating devices. The power system may include a power distribution network which distributes power from the generating devices such as for example the solar arrays 36S to desired systems including the communication system 18. The payload housing may also include or support a cooling system (not shown) arranged to provide both active and passive cooling to the communication system 18.

The communication system 18 generally includes suitable electronics 38 (schematically illustrated in FIG. 1) for transmitter and receiver. The communication system 18, as noted before, also has an antenna system 19 to which the transmitter/receiver electronics 38 are communicably connected to effect in this embodiment a bi-directional communication link L with the ground. As has also been noted before, the antenna system 19 generally comprises feed system 20, and two optical elements 22, 24 as seen in FIG. 1. The first optical element is a subreflector 22 and the second optical element is the main reflector 24 as will be described in greater detail below. In the embodiment shown in FIG. 1, the antenna system 19 is shown as having two optical elements (e.g. subreflector 22 and main reflectors 24) and corresponding feed system 20 for example purposes only. In alternate embodiments, the antenna system may have any suitable number of optical elements (e.g. two subreflector/main reflector pairs) and corresponding feed systems. In other alternate embodiments, the antenna system may have any suitable optical element, such as for example a suitable lens, in lieu of the main reflector shown in FIG. 1.

The feed system 20 is connected to the transmitter electronics 38 by suitable means to distribute radiant energy provided by the transmitter electronics. The feed system 20 may be disposed on the housing 34 as shown in FIG. 1 to generate and direct a beam or beams (indicated generally by arrow B propagating from system 20 in FIG. 1) of radiant energy signals having a desired frequency at the subreflector 22. By way of example, the feed system 20 in this embodiment may comprise a desired number of RF sources 20R each capable of generating a respective beam. In this embodiment, four RF sources 20R are used for example purposes, although the communication system may have any suitable number of RF sources including only one RF source. The RF sources 20R of communication system 18 are substantially the same, though in alternate embodiments different types of RF sources may be used. The construction of RF sources such as RF sources 20R in this embodiment is well known and will be described only briefly herein. Each RF source 20R generally has a beamformer and a radiator (not shown). The beamformer may be coupled via one or more desired filters to the transmitter electronics 38 for generation of the beam of energy for transmission. The radiator of RF source 20R, which may be a single RF horn, is coupled to the beamformer to emit the beam generated by the beamformer. In this embodiment, the beamformer and radiator of each RF source 20R operate so that the beams B propagating from sources 20R of feed system 20 may have circular and elliptical cross-sections.

Still referring to FIG. 1, in this embodiment the subreflector 22 and main reflector 24 of the antenna system 19 are positioned to form a Gregorian antenna. Although the invention will be described below with specific reference to the Gregorian antenna configuration shown, the present invention is equally applicable to any other oval reflector antenna configuration such as for example a Cassegrain antenna. The construction of a Gregorian antenna system is well known. For example, U.S. Pat. No. 5,790,077, which is incorporated by reference herein, discloses a method for constructing a Gregorian antenna system. In this embodiment, the subreflector 22 and main reflector 24 are arranged with a separation distance F (see FIG. 1) of about 187 inches. In this arrangement the subreflector 22 and main reflector 24 have a centerline offset of about 266 inches. In alternate embodiments, the sub-reflector and main reflector of the antenna system may have any other suitable arrangement with respect to each other. The subreflector 22 may be mounted to payload housing 14 as seen in FIG. 1 using mounting structure 40. Mounting structure 40 may include an arm 42 and braces 44 attached to a suitable support on the payload housing. The arm 42 and braces 44 are shown in FIG. 1 as being connected in a general truss configuration, though in alternate embodiments the subreflector support structure may be formed in any other suitable manners using any suitable structural members. The subreflector 22 itself is mounted on a support plate 46 which is connected to the support arm 42 with suitable spacers 48. As can be realized from FIG. 1, the mounting structure 40 of the subreflector may be rigid or “non-collapsible”. Accordingly, the mounting structure 40 may be permanently erected (to the configuration shown in FIG. 1) during fabrication of the payload 14. In alternate embodiments, the subreflector mounting structure may have movable joints allowing the structure to be stowed during launch in a “collapsed” condition and be deployed after launch of the spacecraft and ejection of the launch vehicle fairing. The subreflector 22 may be mounted on support plate 46 in a fixed attitude, or may be provided with suitable attitude adjustment means such as piezo-electric spacers or electro mechanical drives capable of orienting the subreflector as desired. The subreflector 22 may be an assembly of a structure fabricated from honeycomb sandwich material or other spaced layer material and reflective metallic layer 22R disposed over the spaced layer structure. The subreflector structure is formed to have a generally ellipsoid shape of desired dimensions. As can be realized, the spaced layer structure from which its made, causes the subreflector to be substantially rigid such that subreflector cannot be readily “collapsed” for stowage in the launch vehicle fairing. Accordingly, it is desired that the size of the subreflector 22 be such as to allow stowage without interference with the launch vehicle fairing. By way of example, in order to allow stowage inside the fairing of most commercial launch vehicles, the subreflector 22 may have a diameter of about 2.2 meters or about 86 inches. The ellipsoid shape of the subreflector may have a major axis of about 66 inches with the half distance between foci of about 22 inches. In alternate embodiments, the subreflector may have any other suitable dimensions and any suitable shape such as a hyperbolic shape. The reflective layer 22R over the rigid core structure of the subreflector 22 is tuned to reflect the energy beams B radiating from the feed system 20 of the spacecraft 10. The rigid core structure of the subreflector allows the structure to be readily shaped by suitable forming processes so that reflective layer 22R disposed on the core structure has a desired shaped reflective surface 22S. The shaped reflective surface 22S has desired surface “deviations” from the otherwise elliptical shape of the reflective surface. The surface deviations of the shaped reflective surface 22S cause desired distortions of the beam cross-section reflected from the subreflectors as will be described further below.

Referring still to FIG. 1, main reflector 24 of the Gregorian antenna system 19 is mounted to the spacecraft with support arm 48. In this embodiment, a large main reflector is desired. The main reflector 24 may have for example a diameter of about 9.9 meters, though in alternate embodiments the main reflector may have any suitable diameter including diameters of more than 10 meters. A main reflector having this magnitude cannot be stowed within the launch vehicle fairing of most commercial launch vehicles. Accordingly, in order to allow for stowage inside the launch vehicle fairing, and have as large a diameter as possible, the main reflector 24 is unfurlable. The main reflector 24 is furled when stowed in the launch vehicle fairing and unfurled when in the deployed position as shown for example in FIG. 1. As can be realized, support arm 48 may be articulated in a suitable manner so that the arm may be moved from a stowed position (not shown) generally alongside the housing 34 to the deployed position shown in FIG. 1. The unfurlable main reflector 23 may generally comprise central member or hub 49, radially extending or support members (not shown), circumferential tie members (not shown), and a reflective web or mesh 50. The central hub 49 is substantially rigid (for example the hub may be a plate or ring made from metal or composite material) to provide a central support and attachment structure to the arm 48. As seen in FIG. 1, the hub 49 may be connected to the distal end of the articulated arm 48. The radial ribs may be joined in an articulated manner at proximal ends to hub 49 so that the ribs may move, in umbrella like fashion, between its closed position when the reflector 24 is stowed and its open position when the reflector is unfurled as shown in FIG. 1. Circumferential tie members may be disposed to interconnect adjoining ribs, providing the ribs with stability when the reflector 24 is in the deployed position. The reflective web 50 is connected to the ribs and provides the reflective surface 50S of the main reflector 24 when the reflector is unfurled. Suitable bias means (not shown) may be connected to the ribs, ties, and hub to urge the ribs from the furled configuration when the reflector is stowed to the unfurled configuration when deployed. The above described structure of the unfurlable main reflector 24 is merely an example of suitable structure, though the main reflector may have any other suitable unfurlable reflector structure. When the main reflector 24 is unfurled as in its deployed position shown in FIG. 1, the reflective surface 50S has a generally parabolic shape, though in alternate embodiments, the reflective surface of the main reflector may have any suitable shape.

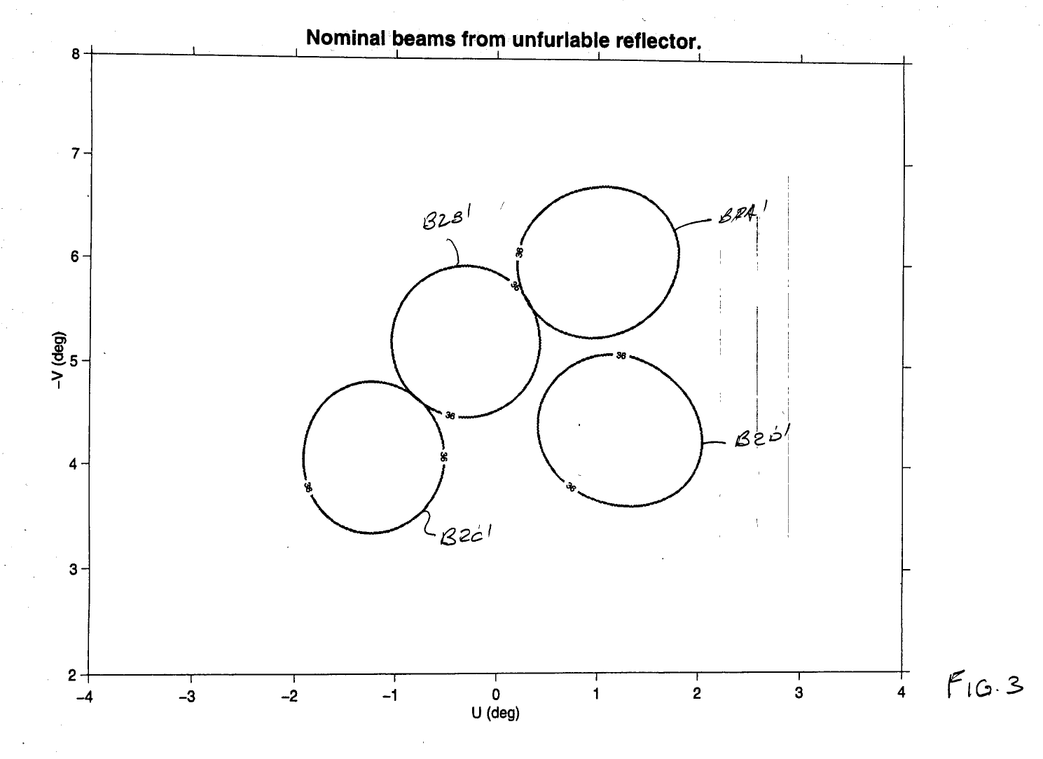

The feed system 20, shaped subreflector 22, and unfurlable main reflector 24 of the dual reflector antenna system 19 on spacecraft 10 operate to illuminate region R on the ground having a footprint with a desired shape. As noted before, the RF sources 20R (i.e. RF horns) generate beams B which have a symmetrically circular (or possibly elliptical) cross-section. Nevertheless, the beams reflected from the main reflector 24 (indicated in general by arrow B2 in FIG. 1) have a desired shaped cross-section to provide the region R illuminated by beams B2 the footprint of desired shape. This is so even though the main reflector 24 is an unfurlable main reflector, and hence does not itself have a shaped reflective surface. The “shaping” of the beams radiating from the dual optical element antenna system 19 in this embodiment is performed by the shaped subreflector 22. FIG. 3 shows a plot which illustrates the cross-section B2A′-B2D′ of four beams reflected from an unfurlable main reflector in a conventional antenna system. In the convention antenna system having an unfurlable main reflector, the beams generated by the feed system have a symmetrically circular cross-section, and retain substantially the same symmetrically circular cross-section when reflected from the main reflector (as shown in FIG. 3). This results in a smaller illuminated region on the ground with possible gaps between areas illuminated by individual adjoining beams as shown in FIG. 3.

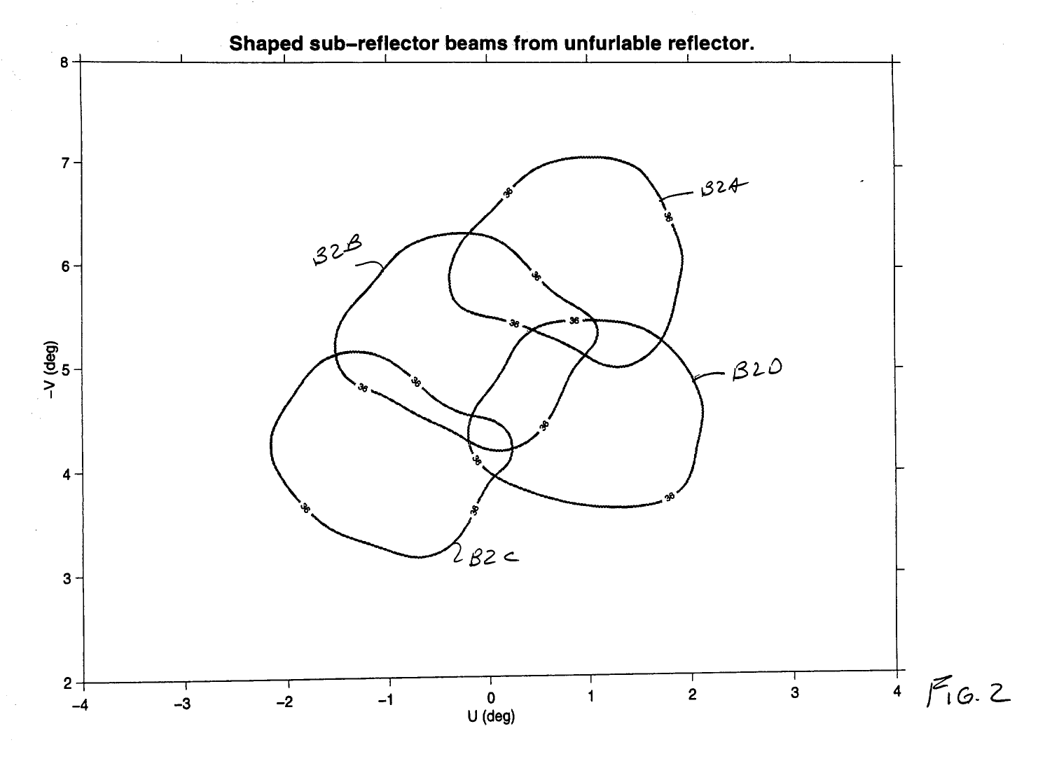

FIG. 2 shows a plot which illustrates the shaped cross-section of four beams B2A-B2D (corresponding to the four RF sources 20R) reflected from the unfurlable main reflector 24 of antenna system 19. The beams B generated initially by the feed system 20 with symmetrically circular cross-sections are “shaped” when reflected (beams B1 in FIG. 1) from the “shaped” reflective surface 22S of the subreflector 22 so that the beams B2 reflected from the unfurlable main reflector 24 have the desired cross-section shapes shown for beams B2A-B2D in FIG. 2. The variations in the shaped reflective surface 22S of the subreflector 22 desirably distort the energy of the beams B transmitted from the feed system 20 to produce a shaped beam radiation pattern in the beams B1 reflected from the subreflector 22 to the main reflector 24 and hence in the beams B2 reflected from the main reflector 24. As can be seen in FIG. 2, the shaped beams B2A-B2D have a larger area and eliminate coverage gaps between the beams. Accordingly, the antenna system 19 on spacecraft 10 provides a high performance “shaped surface” reflector system while permitting the main reflector 24 to be a parabolic in shape (i.e. un-shaped). This allows the use of an unfurlable main reflector, and hence enables the size of the main reflector to be maximized. Moreover, the antenna system need not use a feed cluster operated by a complicated beam forming network to provide the shaped beam from the main reflector. This reduces weight of the antenna system in comparison to conventional antenna systems which has significant advantages in lowering launch costs. Alternate embodiments may however use an antenna feed with a beam forming network if desired.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An antenna system for producing a beam of radiated radio frequency energy, the system comprising:
an antenna feed for supplying radiated radio frequency energy;
a shaped sub-reflector for receiving the radiated radio frequency energy from the antenna feed; and
an unfurlable main reflector for receiving and reflecting the radiated radio frequency energy from the shaped sub-reflector as a shaped beam having a predetermined shape;
wherein the sub-reflector has a configuration that shapes the beam reflected from the unfurlable main reflector to have the predetermined shape.

2. The antenna system of claim 1, wherein the configuration of the shaped sub-reflector determines the shape of the beam reflected from the main reflector.

3. The antenna system of claim 1, wherein the shape of the beam is substantially independent of the configuration of the main reflector.

4. The antenna system of claim 1, wherein the sub-reflector is a rigid structure.

5. The antenna system of claim 1, wherein the main reflector substantially comprises a wire mesh.

6. The antenna system of claim 1, further comprising a furling mechanism for keeping the main reflector furled before deployment.

7. The antenna system of claim 1, wherein the main reflector is substantially parabolic in configuration when the main reflector is unfurled.

8. The antenna system of claim 1, wherein the sub-reflector has a base configuration of one of an elliptical shape or a hyperbolic shape, wherein said base configuration of the sub-reflector is shaped to generate a beam of a predetermined shape.

9. A method for producing a beam of energy of a predetermined shape with an antenna system, comprising the steps of:
supplying radiated radio frequency energy from an antenna feed;
receiving the radiated radio frequency energy in a shaped sub-reflector;
reflecting the radiated radio frequency energy as a shaped beam from the shaped sub-reflector;
receiving the shaped beam in an unfurlable main reflector; and
reflecting the shaped beam with a predetermined shape from the unfurlable main reflector.

10. The method of claim 9, wherein reflecting the radiated radio frequency energy as a shaped beam comprises shaping the radiated radio frequency with the sub-reflector to form the shaped beam, the shaped sub-reflector having a size and shape that determines the shape of the shaped beam.

11. The method of claim 9, wherein the shape of the shaped beam reflected from the main reflector is substantially independent of the configuration of the main reflector.

12. The method of claim 9, wherein the sub-reflector is a rigid structure.

13. The method of claim 9, wherein the main reflector substantially comprises a wire mesh.

14. The method of claim 9, further comprising the step of unfurling the main reflector.

15. The method of claim 9, wherein the main reflector is substantially parabolic in configuration when the main reflector is unfurled.

16. The method of claim 9, wherein the sub-reflector has a base configuration of one of an elliptical shape or a hyperbolic shape, wherein said base configuration of the sub-reflector is shaped to generate a beam of a predetermined shape.

17. A spacecraft comprising:
a spacecraft body; and
an antenna connected to the spacecraft body for producing a beam of radiated energy, the antenna including:
an antenna feed for supplying radiated radio frequency energy;
a shaped sub-reflector for receiving the radiated radio frequency energy from the antenna feed; and
an unfurlable main reflector for receiving and reflecting the radiated radio frequency energy from the shaped sub-reflector as a shaped beam having a predetermined shape;
wherein the sub-reflector has a configuration that shapes the beam reflected from the unfurlable main reflector to have the predetermined shape.

18. The spacecraft of claim 17, wherein the configuration of the sub-reflector includes the size of the sub-reflector and the shape of the sub-reflector.

19. The spacecraft of claim 17, wherein the sub-reflector is rigidly attached to the satellite body.

20. The spacecraft of claim 17, wherein the configuration of the shaped sub-reflector determines the shape of the beam reflected from the main reflector.

21. The spacecraft of claim 17, wherein the shape of the beam is substantially independent of the configuration of the main reflector.

22. The spacecraft of claim 17, wherein the sub-reflector is a substantially rigid structure.

23. The spacecraft of claim 17, wherein the main reflector comprises a wire mesh.

24. The spacecraft of claim 17, further comprising a furling mechanism for keeping the main reflector furled before deployment.

25. The spacecraft of claim 17, wherein the main reflector is substantially parabolic in configuration when the main reflector is unfurled.

26. The spacecraft of claim 17, wherein the sub-reflector has a base configuration of one of an elliptical shape or a hyperbolic shape, wherein said base configuration of the sub-reflector is shaped to generate a beam of a predetermined shape.

27. A spacecraft antenna comprising:
an antenna feed;
a shaped sub-reflector reflecting energy from the antenna feed; and
an unfurlable main reflector for reflecting and directing energy to a predetermined region on the ground;
wherein the shaped sub-reflector is shaped so that the unfurlable main reflector reflects a shaped beam.

28. A spacecraft antenna system comprising:
an antenna feed for supplying a beam of radio frequency energy;
a first optical element for reflecting the beam from the antenna feed; and
a second optical element for reflecting and directing the beam at a predetermined region on the ground, the second optical element being unfurlable, and the beam reflected from the second optical element being a shaped beam having a predetermined shape;
wherein the first optical element changes the shape of the beam from the antenna feed so that the shaped beam reflected from the second optical element has the predetermined shape.
